(19) United States
(12) Patent Application Publication
(10) Pub. No.: US 2006/0224703 A1
(43) Pub. Date: Oct. 5, 2006

(54) Slideshow system, rule server, music reproducing apparatus and methods of controlling said server and apparatus

(75) Inventor: Mika Sugimoto, Asaka-shi (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD.

(21) Appl. No.: 11/391,566

(22) Filed: Mar. 29, 2006

(30) Foreign Application Priority Data
Mar. 30, 2005 (JP) 2005-096664

(51) Int. Cl. G06F 15/16

(52) U.S. Cl. 709/219

(57) ABSTRACT

TOC (Table of Contents) information is read from a music CD and transmitted to a rule server. The latter reads a slideshow rule, which corresponds to the TOC information, from a database and transmits the rule to a client computer. The client computer presents a slideshow in accordance with the slideshow rule while playing the music that has been recorded on the music CD. The slideshow presented is thus harmonized to the music.

### BACKGROUND OF THE INVENTION

1. Field of the Invention

This invention relates to a slideshow system, a rule server, a music reproducing apparatus, methods of controlling the server and apparatus, and a program for controlling the music reproducing apparatus.

2. Description of the Related Art

There are instances where a personal computer can be used to present a slideshow for displaying images of a number of frames one after another. The usual slideshow merely changes over images at regular time intervals.

Further, since personal computers are capable of reproducing music data that has been recorded on a CD (Compact Disk), there are personal computers that display video while reproducing music (see the specification of Japanese Patent Application Laid-Open No. 2003-281862).

There are also devices that read TOC (Table of Contents) information on a CD, refer to song titles, artist names and genre, etc., contained in the read TOC information and utilize these when music is reproduced (see the specification of Japanese Patent Application Laid-Open No. 2001-283568).

In any case, the prior art does give consideration to the presentation of a slideshow harmonized to music that is being reproduced.

### SUMMARY OF THE INVENTION

Accordingly, an object of the present invention is to present a slideshow harmonized to music that is being reproduced.

According to a first aspect of the present invention, the foregoing object is attained by providing a slideshow system comprising a music reproducing apparatus and a rule server that are capable of communicating with each other.

The music reproducing apparatus includes a music-data reading device for reading music data that has been recorded on a recording medium; a unique-information reading device for reading unique information that has been recorded on the recording medium; and a unique-information transmitting device for transmitting the unique information, which has been read by the unique-information reading device, to the rule server.

The rule server includes a slideshow-rule storage device for storing a number of slideshow rules; a slideshow-rule search device for finding a slideshow rule based upon unique information, which has been transmitted from the unique-information transmitting device of the music reproducing apparatus, from among the number of slideshow rules that have been stored in the slideshow-rule storage device; and a slideshow-rule transmitting device for transmitting the slideshow rule, which has been found by the slideshow-rule search device, to the music reproducing apparatus.

The music reproducing apparatus further includes a music reproducing device for reproducing music data, which has been read by the music-data reading device of the music reproducing apparatus, and outputting music; and a display device for presenting images in a slideshow in accordance with a slideshow rule that is for presenting a slideshow in accordance with the output of music from the music reproducing device, the slideshow rule having been transmitted from the slideshow-rule transmitting device of the rule server.

According to a second aspect of the present invention, the foregoing object is attained by providing a music reproducing apparatus that constitutes the above-described slideshow system. In the second aspect of the present invention, the music reproducing apparatus, which is capable of communicating with a rule server, comprises a music-data reading device for reading music data that has been recorded on a recording medium; a music reproducing device for reproducing music data that has been read by the music-data reading device and outputting music; a unique-information reading device for reading unique information that has been recorded on the recording medium; a unique-information transmitting device for transmitting the unique information, which has been read by the unique-information reading device, to the rule server; and a display device for presenting images in a slideshow in accordance with a slideshow rule that is for presenting a slideshow in accordance with the output of music from the music reproducing device, the slideshow rule having been transmitted from the rule server and found based upon the unique information that has been transmitted from the unique-information transmitting device.

The second aspect of the present invention also provides a control method suited to the above-described music reproducing apparatus. Specifically, the second aspect of the present invention provides a method of controlling a music reproducing apparatus capable of communicating with a rule server, the method comprising the steps of: reading music data that has been recorded on a recording medium; reproducing the music data that has been read and outputting music; reading unique information that has been recorded on the recording medium; transmitting the read unique information to the rule server; and presenting images in a slideshow in accordance with a slideshow rule that is for presenting a slideshow in accordance with output of music from the music reproducing apparatus, the slideshow rule having been transmitted from the rule server and found based upon the unique information that has been transmitted to the rule server.

The second aspect of the present invention also provides a program for controlling the above-described music reproducing apparatus.

According to a third aspect of the present invention, the foregoing object is attained by providing a rule server that constitutes the slideshow system. In the third aspect of the present invention, the rule server, which is capable of communicating with a music reproducing apparatus, comprises a slideshow-rule storage device for storing a number of slideshow rules; a slideshow-rule search device for finding a slideshow rule based upon unique information of a recording medium, which has been transmitted from the music reproducing apparatus, from among the number of slideshow rules that have been stored in the slideshow-rule storage device; and a slideshow-rule transmitting device for transmitting the slideshow rule, which has been found by the slideshow-rule search device, to the music reproducing apparatus.

The third aspect of the present invention also provides a control method suited to the above-described music reproducing apparatus. Specifically, the third aspect of the present invention provides a method of controlling a rule server capable of communicating with a music reproducing apparatus, the method comprising the steps of: storing a number of slideshow rules in a slideshow-rule storage device in advance; finding a slideshow rule based upon unique information of a recording medium, which has been transmitted from the music reproducing apparatus, from among the number of slideshow rules that have been stored in the slideshow-rule storage device; and transmitting the slideshow rule that has been found to the music reproducing apparatus.

In accordance with the present invention, a number of slideshow rules are stored in a rule server in advance. When unique information that has been recorded on the recording medium is read in a music reproducing apparatus, the read unique information is transmitted from the music reproducing apparatus to the rule server. When the unique information is received by the rule server, a slideshow rule is found based upon the received unique information. The found slideshow rule is transmitted from the rule server to the music reproducing apparatus. The latter reproduces music data read from the recording medium and outputs music. Images are presented in a slideshow, in conformity with the music output, in accordance with the slideshow rule that has been transmitted from the server.

Thus, a slideshow rule conforming to music that is output from a music reproducing apparatus can be found and a slideshow that is harmonized to this music can be realized.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram illustrating the electrical configuration of a slideshow system;

FIG. 2 illustrates an example of a database of slideshow rules;

FIG. 3 is a flowchart illustrating processing for acquiring a slideshow rule;

FIG. 4 is a flowchart illustrating processing for implementing a slideshow;

FIG. 5 illustrates an example of a slideshow rule; and

FIGS. 6A to 6E illustrate example of images displayed in a slideshow.

### DESCRIPTION OF THE PREFERRED EMBODIMENT

A preferred embodiment of the present invention will now be described in detail with reference to the accompanying drawings.

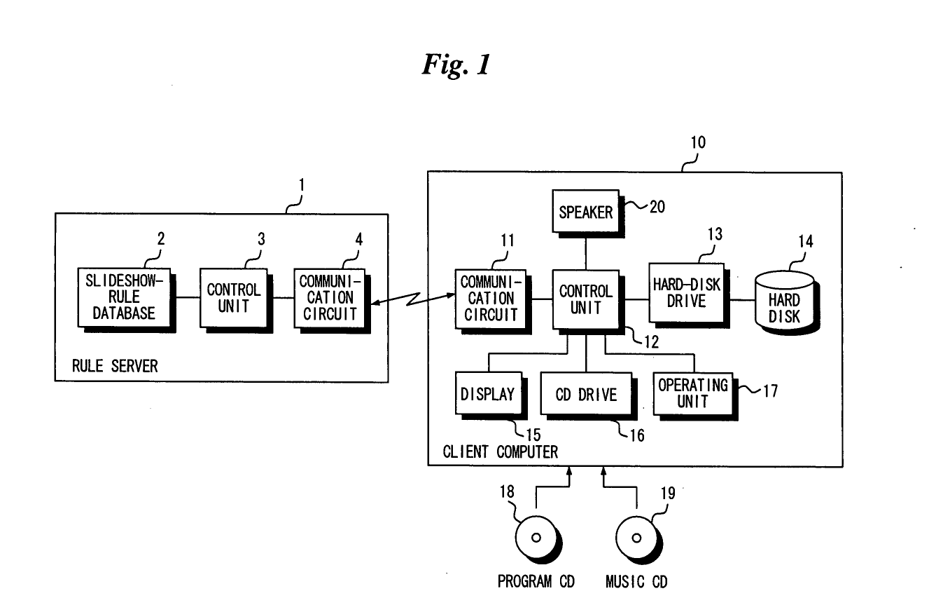

FIG. 1 is a block diagram illustrating the electrical configuration of a slideshow system according to a preferred embodiment of the present invention.

The slideshow system includes a rule server 1 and a client computer (music reproducing apparatus) 10 that are capable of communicating with each other.

The client computer 10 in the slideshow system according to this embodiment reads music data, which has been recorded on a music CD 19, and reproduces music represented by the music data. In conformity with such music playback, the client computer 10 presents a slideshow suited to the music.

The rule server 1 includes a slideshow-rule database 2. A number of rules for slideshows implemented in the client computer 10 have been stored in the slideshow-rule database 2 in association with TOC information (unique information) that has been recorded on the music CD 19.

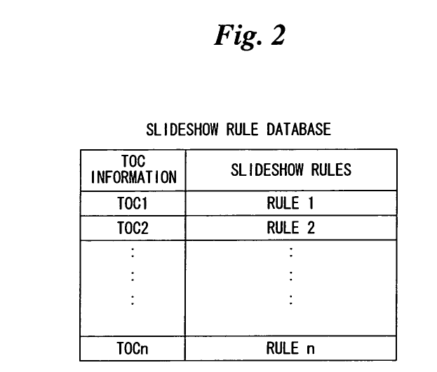

FIG. 2 illustrates an example of TOC information and slideshow rules that have been stored on the slideshow-rule database 2.

A number of slideshow rules have been stored in the slideshow-rule database 2 in association with TOC information, as mentioned above. The slideshow rules describe rules according to which slideshows are presented, the slideshows being suited to music that has been recorded on music CDs specified by TOC information. For example, if music data that has been recorded on a music CD specified by TOC information represents slow music, a slideshow rule according to which a slow slideshow is presented is stipulated. If the music data that has been recorded on a music CD specified by TOC information represents quick-tempo music, then the slideshow rule stipulated is one according to which movement and changeover, etc., of images change at the same tempo.

The TOC information includes the number of songs and play times of the music that has been recorded on the music CD. For the sake of simplicity, here the TOC information will be treated as information that is capable merely of specifying the music CD. Of course, in a case where artist names and song titles and the like have been recorded in the TOC information, slideshow rules may be stored in association with these artist names and song titles, etc. A slideshow can thus be presented in accordance with artists and song titles. In a case where a slideshow conforming to a song is presented, the song can be divided into an introductory segment, a so-called A-melody segment, a so-called B-melody segment and a bridge segment, and the slideshow can be presented so as to accentuate the bridge segment.

With reference again to FIG. 1, the rule server 1 includes a communication circuit 4 for communicating with the client computer 10. TOC information that has been transmitted from the client computer 10 is received by the communication circuit 4, and a slideshow rule that corresponds to the received TOC information is read from the slideshow-rule database 2 by a controller 3. The read slideshow rule is transmitted from the rule server 1 to the client computer 10.

The operation of the overall client computer 10 is controlled by a control unit 12.

Connected to the control unit 12 are a display unit 15 for presenting a slideshow, a CD drive 16 for reading a music CD 19 and data that has been recorded on a program CD 18 storing an operating program (described later), and an operating unit 17.

The client computer 10 includes a hard disk 14 and a hard-disk drive 13 for writing data to and reading data from the hard disk 14. Data that has been read by the CD drive 16 is written to the hard disk 14 by the hard-disk drive 13. Image data representing images displayed in a slideshow has also been recorded on the hard disk 14. Also recorded on the hard disk 14 are slideshow rules that have been transmitted from the rule server 1.

The client computer 10 is further provided with a speaker 20 for outputting music data, which has been read from the music CD 19, as music. The client computer 10 also includes a communication circuit 11 for communicating with the rule server 1.

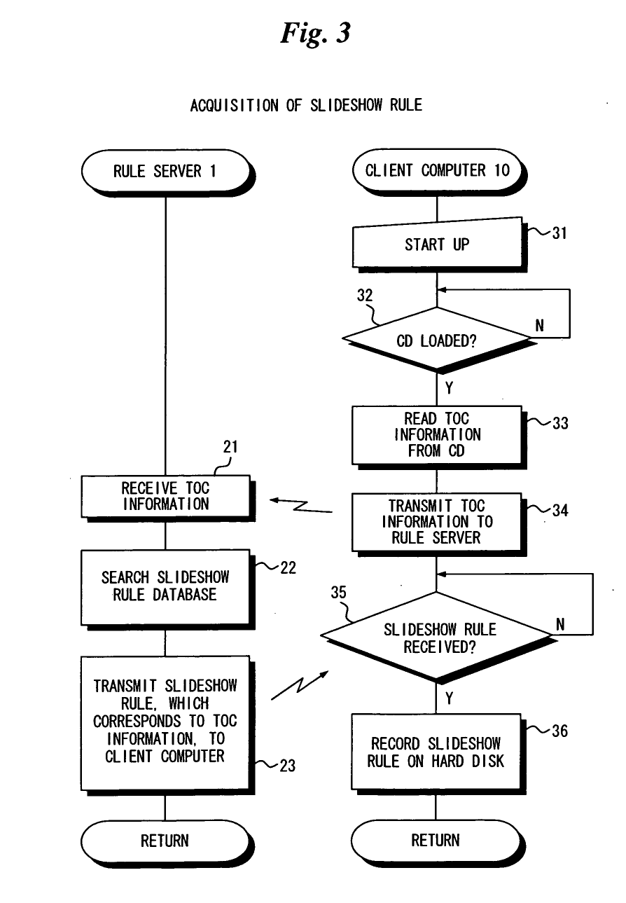

FIG. 3 is a flowchart illustrating processing executed by the client computer 10 to acquire slideshow rules.

First, the client computer 10 is started up (step 31) and whether the music CD 19 has been loaded in the CD drive 16 is checked (step 32). If the music CD 19 has been loaded (“YES” at step 32), the TOC information that has been recorded on the music CD 19 is read (step 33). The TOC information is unique to the music CD 19. The read TOC information is transmitted from the client computer 10 to the rule server 1 (step 34).

When the TOC information transmitted from the client computer 10 is received by the rule server 1 (step 21), the latter searches the slideshow-rule database 2 and retrieves from the slideshow-rule database 2 the slideshow rule that corresponds to the received TOC information (step 22), as described above. The retrieved slideshow rule is transmitted from the rule server 1 to the client computer 10 (step 23).

When the slideshow rule transmitted from the rule server 1 is received by the client computer 10 (step 35), the latter records the received slideshow rule on the hard disk 14 (step 36).

Thus there is obtained a rule for implementing a slideshow suited to the music that has been recorded on the music CD 19 loaded in the client computer 10.

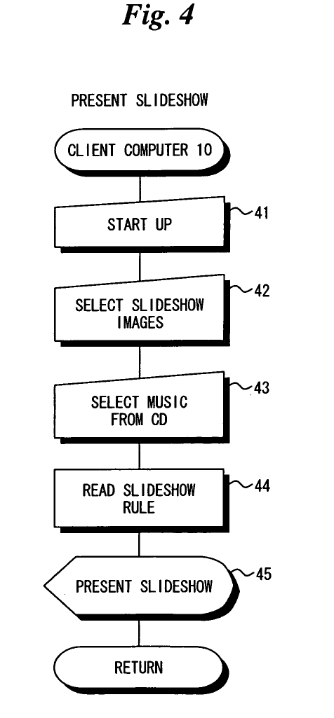

FIG. 4 is a flowchart illustrating processing executed by the client computer 10 to present a slideshow.

The music CD 19 is loaded in the client computer 10.

The client computer 10 is started up (step 41) and images to be utilized in the slideshow are selected from the image data that has been recorded on the hard disk 14 (step 42). It goes without saying that if the images utilized in the slideshow have been predetermined, then selecting the images will be unnecessary. Next, the music to be played from the music CD 19 is selected (step 43). The slideshow rule that has been recorded on the music CD 19 is read (step 44) and a slideshow harmonized to this music is presented while the music is played (step 45).

It goes without saying that it may be so arranged that a slideshow rule is transmitted to the client computer 10 for every song, thereby allowing the presentation of a slideshow that is in accordance with a slideshow rule corresponding to a song selected by the user.

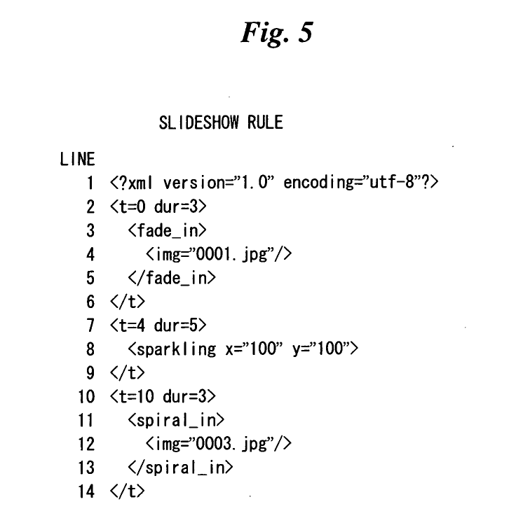

FIG. 5 illustrates an example of a slideshow rule.

The first line of the rule describes the version, etc., of the description language of the slideshow rule.

Lines 2 to 6 indicate that an image having a file name 0001.jpg is to be faded in and displayed over a period of three seconds starting from time t=0.

Lines 7 to 9 indicate that a star symbol is to be made to shine and be displayed (in a so-called “sparkling display”) at coordinates (x,y)=(100,100) over a period of five seconds starting from time t=4.

Lines 10 to 14 indicate that an image having a file name 0003.jpg is to be spiraled in and displayed over a period of three seconds starting from time t=10.

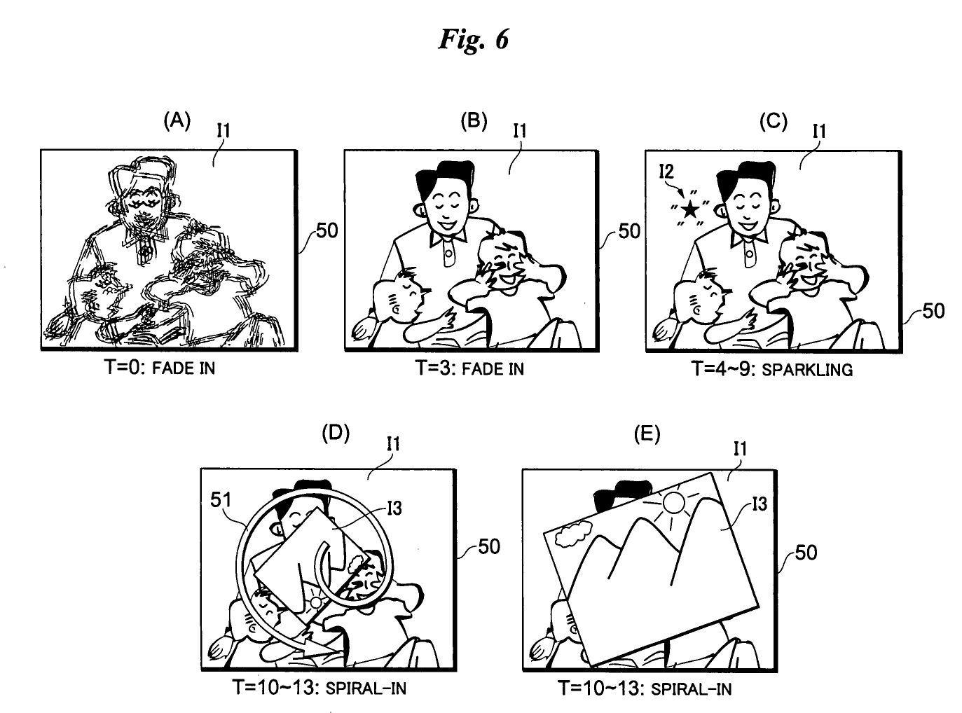

FIGS. 6A to 6E illustrate the manner in which a slideshow is presented in accordance with the slideshow rule shown in FIG. 5.

As shown in FIGS. 6A and 6B, an image I1 having the file name 0001.jpg starts to appear gradually (to fade in) on a display screen 50 of the display unit 15. That is, the image undergoes a transition from blurry to sharp.

As shown in FIG. 6C, a star symbol I2 shines at the position of coordinates (x,y)=(100,100) for five seconds starting from time t=4.

As shown in FIGS. 6D to 6E, an image I3 having the file name 0003.jpg is displayed in spiraling-in fashion in such a manner that the image is gradually enlarged while being rotated spirally over a period of three seconds starting from time t=10. It goes without saying that although the spiral 51 is shown in order to indicate the fact that the image I3 is rotated spirally in FIGS. 6D and 6E, the spiral need not be displayed.

Such a slideshow is presented together with the playing of music by the client computer 10. Thus, a slideshow harmonized to the reproduced music is achieved.

In the embodiment described above, the slideshow is presented while music data is read from the loaded music CD 19. However, the music data may be recorded on the hard disk 14 and the music may be played back while being read from the hard disk 14. Further, it may be so arranged that if a single rule cannot be decided upon from the TOC information that has been transmitted from the client computer 10 to the rule server 1, then a plurality of slideshow rules are transmitted from the rule server 1 to the client computer 10 and the user of the client computer 10 is allowed to select the rule.

As many apparently widely different embodiments of the present invention can be made without departing from the spirit and scope thereof, it is to be understood that the invention is not limited to the specific embodiments thereof except as defined in the appended claims.

What is claimed is:

1. A slideshow system comprising a music reproducing apparatus and a rule server that are capable of communicating with each other, wherein said music reproducing apparatus includes:
a music-data reading device for reading music data that has been recorded on a recording medium;
a unique-information reading device for reading unique information that has been recorded on the recording medium; and
a unique-information transmitting device for transmitting the unique information, which has been read by said unique-information reading device, to said rule server;
said rule server includes:
a slideshow-rule storage device for storing a number of slideshow rules;
a slideshow-rule search device for finding a slideshow rule based upon the unique information, which has been transmitted from said unique-information transmitting device of said music reproducing apparatus, from among the number of slideshow rules that have been stored in said slideshow-rule storage device; and
a slideshow-rule transmitting device for transmitting the slideshow rule, which has been found by said slideshow-rule search device, to said music reproducing apparatus; and
said music reproducing apparatus further includes:
a music reproducing device for reproducing music data, which has been read by said music-data reading device of said music reproducing apparatus, and outputting music; and
a display device for presenting images in a slideshow in accordance with a slideshow rule that is for presenting a slideshow in accordance with the output of music from said music reproducing device, said slideshow rule having been transmitted from said slideshow-rule transmitting device of said rule server.

2. A music reproducing apparatus capable of communicating with a rule server, comprising:
a music-data reading device for reading music data that has been recorded on a recording medium;
a music reproducing device for reproducing music data that has been read by said music-data reading device and outputting music;
a unique-information reading device for reading unique information that has been recorded on the recording medium;
a unique-information transmitting device for transmitting the unique information, which has been read by said unique-information reading device, to said rule server; and
a display device for presenting images in a slideshow in accordance with a slideshow rule that is for presenting a slideshow in accordance with the output of music from said music reproducing device, said slideshow rule having been transmitted from said rule server and found based upon the unique information that has been transmitted from said unique-information transmitting device.

3. A rule server capable of communicating with a music reproducing apparatus, comprising:
a slideshow-rule storage device for storing a number of slideshow rules;
a slideshow-rule search device for finding a slideshow rule based upon unique information of a recording medium, which information has been transmitted from said music reproducing apparatus, from among the number of slideshow rules that have been stored in said slideshow-rule storage device; and
a slideshow-rule transmitting device for transmitting the slideshow rule, which has been found by said slideshow-rule search device, to said music reproducing apparatus.

4. A method of controlling a music reproducing apparatus capable of communicating with a rule server, said method comprising the steps of:
reading music data that has been recorded on a recording medium;
reproducing the music data that has been read and outputting music;
reading unique information that has been recorded on the recording medium;
transmitting the read unique information to the rule server; and
presenting images in a slideshow in accordance with a slideshow rule that is for presenting a slideshow in accordance with output of music from the music reproducing apparatus, said slideshow rule having been transmitted from the rule server and found based upon the unique information that has been transmitted to the rule server.

5. A method of controlling a rule server capable of communicating with a music reproducing apparatus, said method comprising the steps of:
storing a number of slideshow rules in a slideshow-rule storage device in advance;
finding a slideshow rule based upon unique information of a recording medium, which information has been transmitted from the music reproducing apparatus, from among the number of slideshow rules that have been stored in the slideshow-rule storage device; and
transmitting the slideshow rule that has been found to the music reproducing apparatus.

6. A program for controlling a music reproducing apparatus capable of communicating with a rule server, said program controlling the music reproducing apparatus so as to cause said apparatus to:
read music data that has been recorded on a recording medium;
reproduce the music data that has been read and output music;
read unique information that has been recorded on the recording medium;
transmit the read unique information to the rule server; and
present images in a slideshow in accordance with a slideshow rule that is for presenting a slideshow in accordance with output of music from the music reproducing apparatus, said slideshow rule having been transmitted from the rule server and found based upon the unique information that has been transmitted to the rule server.
